(19) United States
(12) Patent Application Publication
(10) Pub. No.: US 2003/0227864 A1
(43) Pub. Date: Dec. 11, 2003

(54) Scratchless CD/DVD (CD-ROM/CD-RW/MD)

(76) Inventor: Marlon Louis Hertzog, Alexandria, LA (US)

Correspondence Address: Marlon L. Hertzog, 2410 East Texas Avenue, Alexandria, LA, 71301, US

(21) Appl. No.: 10/162,784

(22) Filed: Jun. 6, 2002

(51) Int. Cl. G11B 23/03

(52) U.S. Cl. 369/291

(57) ABSTRACT

The Scratchless CD/DVD (CD-ROM/CD-R/CD-RW/MD) is a permanent cover that encloses a compact disc, a digital video disc, a compact disc-read only memory, a compact disc-record, a compact disc-rewrite, or a mini disc. The hard plastic permanent cover is designed to house an optical disk on which sound, data, or images is recorded in a digital format and prevent the device from being scratched or damaged from reading devices and normal wear and tear. This permanent cover eliminate the need to replace a CD/DVD (CD-ROM/CD-R/CD-RW/MD) by protecting it from scratches and harm, however, the cover does not interfere with the operation of the CD/DVD (CD-ROM/CD-R/CD-RW/MD).

### BACKGROUND OF THE INVENTION

The Scratchless CD/DVD (CD-ROM/CD-R/CD-RW/MD) is a simple and effective product designed as a permanent cover for Compact Discs, Digital Video Discs, Compact Discs-Read Only Memory, recordable CD's, rewriteable CD's or Mini Discs. It prevents the CD/DVD (CD-ROM/CD-R/CD-RW/MD) contained within from scratches or other types of damage due to normal usage, handling, and storage. The idea was inspired by the problem of having to frequently replace damaged compact discs and digital video discs. Having looked at other storage devices such as floppy discs, the problem of scratches and damage are virtually eliminated by the permanent cover in which the device is contained. This cover does not interfere with the operation of the storage device. This device was worked on for approximately six months prior to the date of filing the disclosure document (Document No. 493084 PTO-1652 (July 1999)).

### SUMMARY OF THE INVENTION

The Scratchless CD/DVD (CD-ROM/CD-R/CD-RW/MD) is a permanent cover for a CD/DVD (CD-ROM/CD-R/CD-RW/MD) that prevents the storage device from scratches or other damages from user handling in compliance with storage device recommended safe handling practices. The Scratchless CD/DVD (CD-ROM/CD-R/CD-RW/MD) semi-circular version has a stop tab that prevents the cover from rotating while in use. The square version by virtue of shape prevents the cover from rotating while in use. The Scratchless CD/DVD (CD-ROM/CD-R/CD-RW/MD) also include a spring-loaded site window cover to protect the storage device while handling and storage. The site window allows the reading device (laser) to retrieve or store (i.e. CD-R/CD-RW) data to/from the CD/DVD contained inside as with normal CD/DVD operations. The square version contains a switch to allow/not allow the rewrite/recording of data over a CD-R/CD-RW and can be controlled by the user. The hard plastic material that makes up the cover can be made in any color with graphics and labeling affixed to the cover as designated by the manufacturer. In addition, slight modifications can be made to the cover as deemed necessary by the manufacturer.

### BRIEF DESCRIPTION OF THE DRAWINGS

FIG. 1 is the outer view of the Scratchless CD/DVD (CD-ROM/CD-R/CD-RW/MD); square version with CD inside.

FIG. 2 is the bottom cover; inner view

FIG. 3 is the top cover; inner view

FIG. 4A is the site window cover

FIG. 4B is the side view of the site window cover

FIG. 5 is the bottom outside cover; semi-circular version

FIG. 6 is the bottom cover; inner view

FIG. 7 is the top cover; inner view

FIG. 8A is the side view of the site window cover

FIG. 8B is the bottom view of the site window cover

### DETAILED DESCRIPTION OF THE PREFERRED EMBODIMENTS

First Embodiment

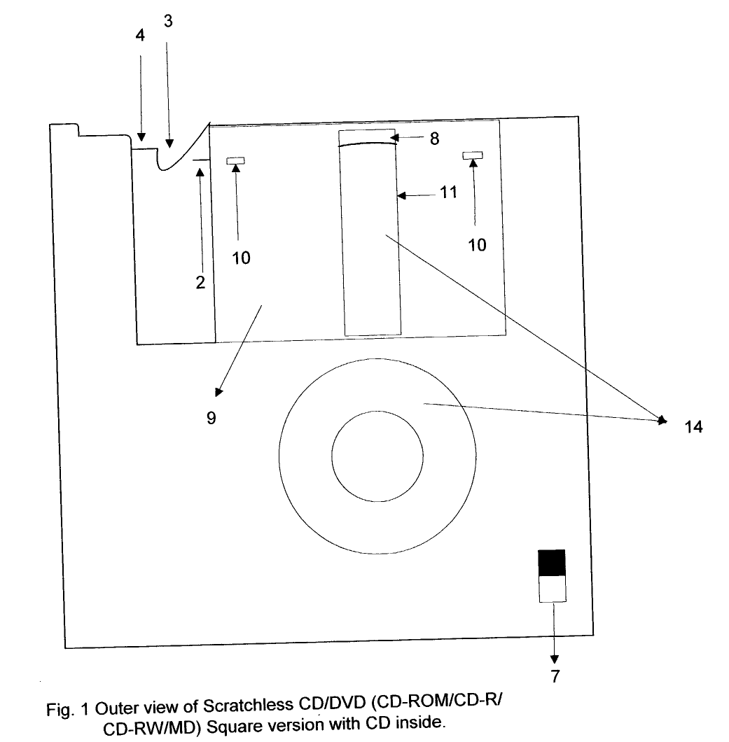

A first embodiment of the Scratchless CD/DVD (CD-ROM/CD-R/CD-RW/MD) cover of present invention, as shown in FIG. 1 has two sides which are mounted together. The CD/DVD inside 14 with the site window cover 9 in the open position. The contact initiating point 4 where the player site window opening device contacts the site window and force it open. This device then maintains the site window open when it reaches the locking point 3 and allows the reading device (laser) to read data from the disc 14 via the site window 8 which is aligned with the site window for the site window cover 11. The guide groove 2 allows the site window cover 9 to move back and forward straight and true due to the guide tabs 10 that are punched from the metal site window cover 9 to create metal prongs to follow the guide groove 2. For CD-R and CD-RW the rewrite switch 7 allow the user to control whether or not data can be written on to the disc.

Second Embodiment

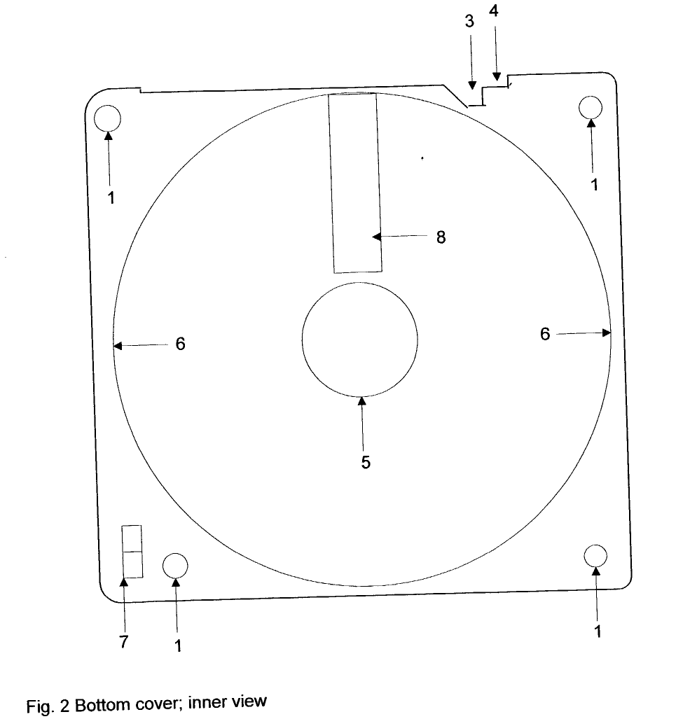

FIG. 2 shows the inner side of the bottom cover in which the mounting points 1 fit into the mounting points of the other side. The disc guide lip 6 allow the disc to rotate within the cover without restricting rotation but doesn't allow the disc to misalign itself. The rotation access hole 5 is larger than a disc hole as to not interfere with the player rotation axle. The site window 8 allow the reader (laser) to interface with the disc. Also the contact initiating point 4 and locking point 3 allow site window cover to be opened. The rewrite switch 7 is used for CD-R and CD-RW.

Third Embodiment

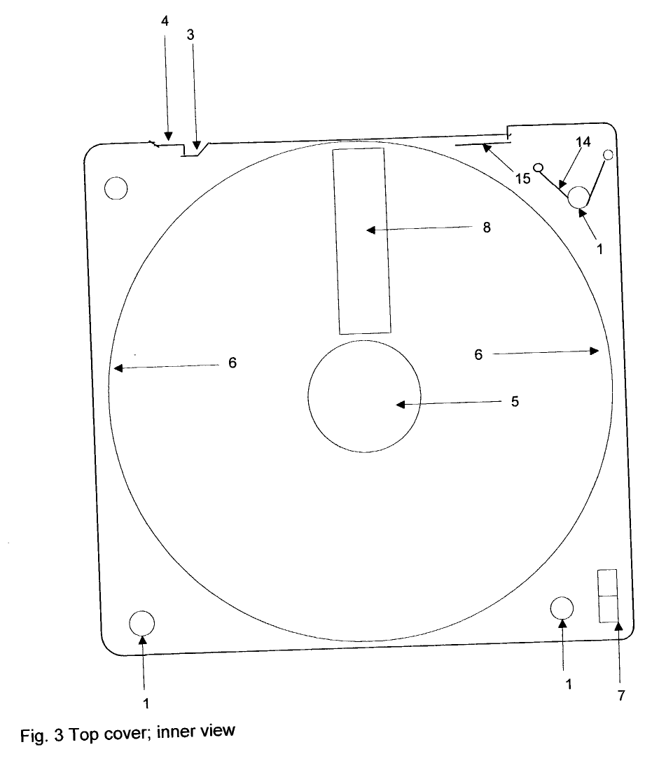

FIG. 3 shows the inner side of the top cover to be joined to the bottom cover via mounting points 1. The site window cover spring 14 is held in place by the mounting point 1 and keeps the window closed when the reader is not manipulating the disc. The guide groove 15 guides the site window cover and holds it in place. The disc guide lip 6 allow the disc to rotate within the cover without restricting rotation but doesn't allow the disc to misalign itself. The rotation access hole 5 is larger than a disc hole as to not interfere with the player rotation axle. The site window 8 allow the reader (laser) to interface with the disc. Also the contact initiating point 4 and locking point 3 allow site window cover to be opened. The rewrite switch 7 is used for CD-R and CD-RW.

Fourth Embodiment

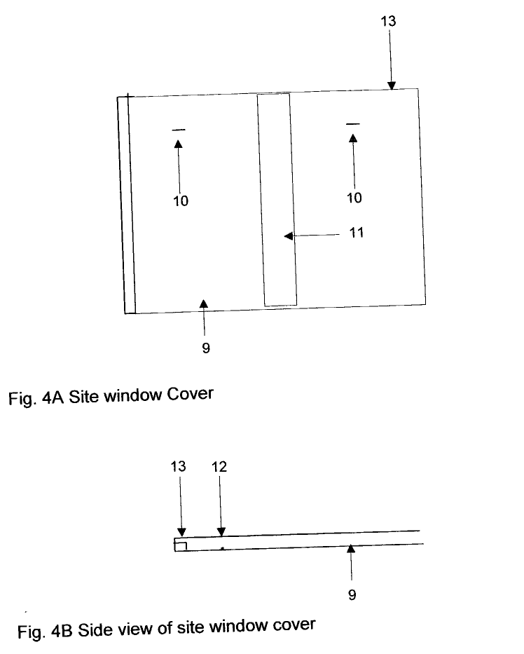

FIG. 4A show the site window cover 9 itself and the site window cover site window 11. The site window cover spring attachment point and guide 13 is an attachment point protruding into the disc cover for the spring force displacement point and also attaches to a groove inside the disk top cover inner side shown by FIG. 3, 15 to guide the site window cover 9. The guide tabs for the site window 10 guide the window and holds it on the cover.

FIG. 4B show a side view of the site window cover 9 and the L shape site window cover spring attachment point and guide 13. It also illustrates the prongs created by the punched out guide tabs 10.

Fifth Embodiment

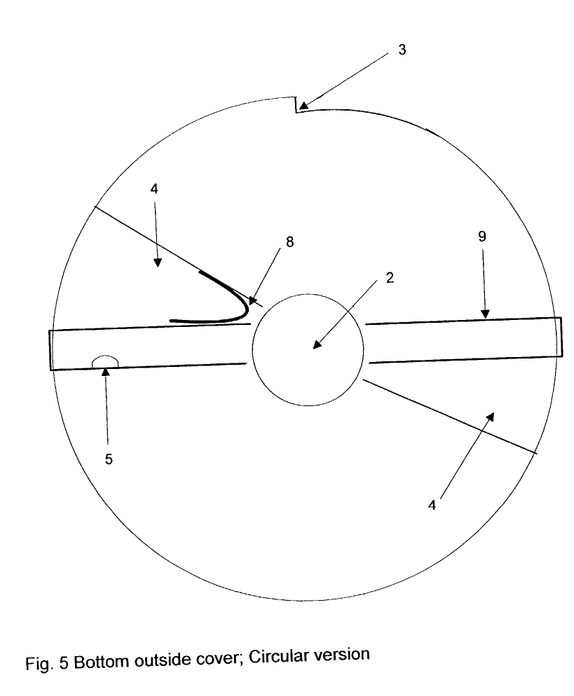

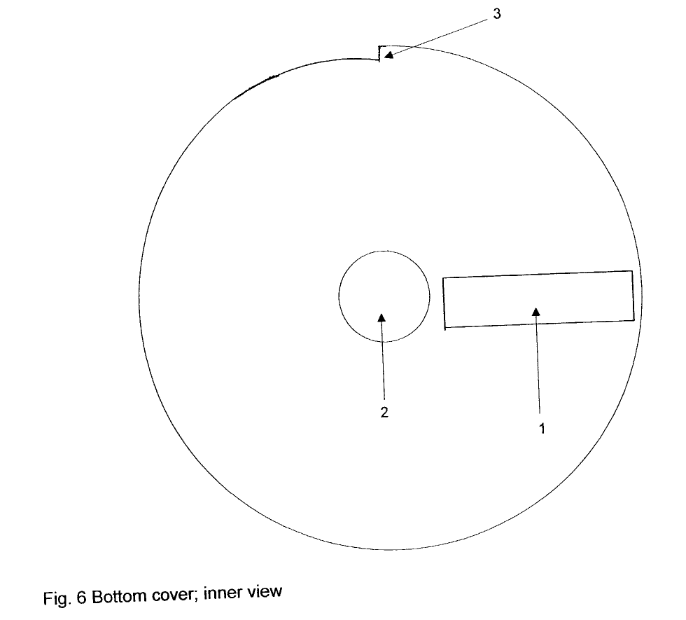

FIG. 5 shows a circular version of the scratchless optical device cover which utilizes a stop tab 3 so that the cover does not rotate while the optical device disc inside does. The rotation axle access hole 2 is shown which is larger than the actual disc hole in order not to interfere with the rotation axle of the player. The site window cover 9 conceals the site window FIG. 6, 1 while in the closed position. The site window cover spring 8 provides the tension necessary to keep the site window 9 in the closed position while the disc is not in use. The annointed area 4 limits the movement of the site window cover 9 and provides a tension force support for the spring 8. The site window cover contact initiating point 5 is a raised tab on the site window cover 9 to allow the player a contact area for opening the site window cover 9.

Sixth Embodiment

FIG. 6 illustrates the bottom inner cover with stop tab 3 necessary to stop cover rotation, rotation axle access hole 2, and the site window 1 that allows the player to manipulate the disc inside.

Seventh Embodiment

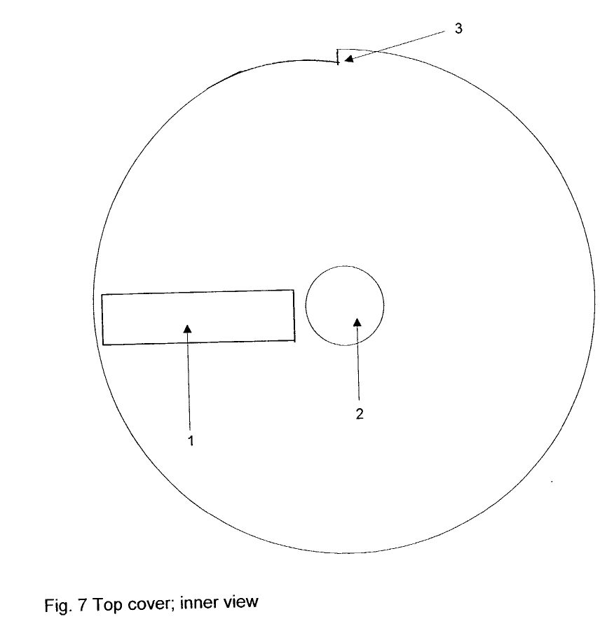

FIG. 7 illustrates the top inner cover with stop tab 3 necessary to stop cover rotation, rotation axle access hole 2, and the site window 1 that allows the player to manipulate the disc inside.

Eighth Embodiment

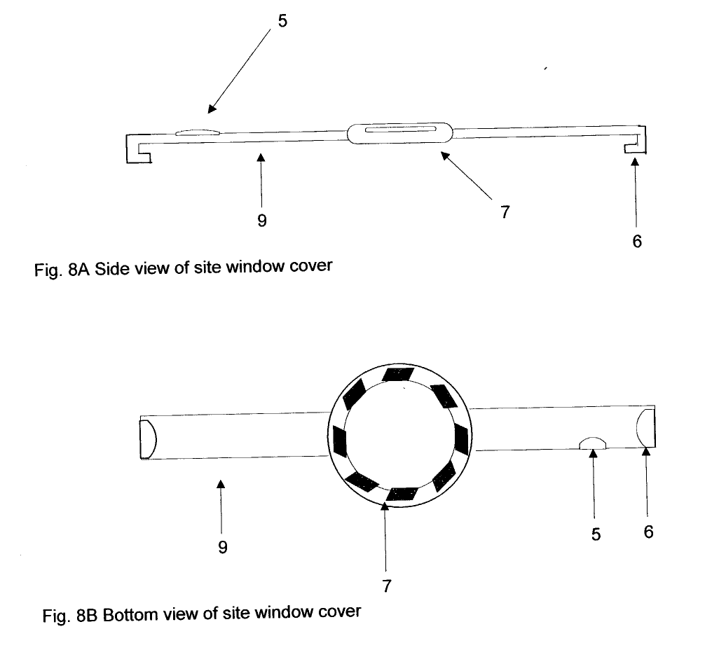

FIG. 8A illustrates a side view of the site window cover 9 with the site window cover contact initiating point 5. The site window cover 9 actually overlaps the sides of the optical disc cover to increase stability. The site window cover positioning tabs 7 protrude through the rotation axle access hole FIG. 7, 2 and stabilize the site window cover 9 and also creates a pivoting point.

FIG. 8B illustrates a bottom view of the site window cover 9 with the site window cover contact initiating point 5. The site window cover 9 actually overlaps the sides of the optical disc cover 6 to increase stability. The site window cover positioning tabs 7 protrude through the rotation axle access hole FIG. 7, 2 and stabilize the site window cover 9 and also creates a pivoting point.

What is claimed is:

1. The Scratchless CD/DVD (CD-ROM/CD-R/CD-RW/MD) utilizes two sides of a hard plastic cover that attaches together to permanently protect the data on optical storage devices and the like with a site window cover to protect the optical device while handling and storage by the user.
